(19) United States
(12) Patent Application Publication
(10) Pub. No.: US 2005/0119870 A1
(43) Pub. Date: Jun. 2, 2005

(54) Processor system with execution-reservable accelerator

(76) Inventors: Koji Hosogi, Hiratsuka (JP); Yukio Fujii, Yokohama (JP); Kazuhiko Tanaka, Fujisawa (JP); Hiroaki Nakata, Kawasaki (JP); Masakazu Ehama, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/982,830

(22) Filed: Nov. 8, 2004

(30) Foreign Application Priority Data
Nov. 26, 2003 (JP) 2003-395995

(51) Int. Cl. G06F 17/50

(52) U.S. Cl. 703/15; 703/21

(57) ABSTRACT

A processor system capable of performing high-speed image processing is provided. The processor system includes a CPU and an accelerator. The CPU connected to the accelerator issues reservations of activation requests to said accelerator. The accelerator has an issued request number counter for counting the number of requests issued by the CPU and a processed request number counter for counting the number of processed requests. The accelerator can activate itself when a counter value of the issued request number counter is larger than a counter value of the processed request number counter.

### INCORPORATION BY REFERENCE

The present application claims priority from Japanese application JP2003-395995 filed on Nov. 26, 2003, the content of which is hereby incorporated by reference into this application.

### BACKGROUND OF THE INVENTION

The present invention relates to a processor system having an execution-reservable accelerator, and particularly to a processor system capable of performing high-speed processing.

In media processing where a real-time MPEG processing capability or an enhanced processing capability is required, an MPEG LSI having fixed functions or another hard-wired dedicated chip was used. In recent years, however, software-based approaches using a media processor containing a media computing unit are highlighted.

The media processor includes a host of computing units specially designed for media processing, and can comply with information of various standards with the aid of software. In addition, the media processor can be implemented as a single chip that has different functions such as image processing and sound processing functions. In order to obtain high computing performance in the media computing units, the media processor has an enhanced data transfer system and a dedicated accelerator so as to enhance the performance in parallel computation and achieve real-time processing based on software.

JP2002-527824 discloses a multimedia system having a data transfer accelerator (data streamer) in addition to a CPU for executing media processing so as to achieve distributed processing for media processing and data transfer and thereby enhance the performance. This system achieves data transfer using chainable channels, and achieves a chain of a plurality of data transfer jobs.

Thus, when access addresses are known, the channels are chained so that parallel processing can be achieved without aid of the CPU.

In the MPEG decoding process in the background art, an image decoding process of one frame is performed using an algorithm in which the frame is divided into small blocks called macroblocks, and processing is performed upon an entered bitstream on a macroblock-by-macroblock basis. In the MPEG decoding process, processing needing two-dimensional block transfer, called a motion compensation process, has significant weight with respect to the MPEG decoding process as a whole. For the block transfer in the motion compensation process, an access address to be used therefor is generated at random. It is therefore necessary to generate the address whenever the address is required.

To achieve such data transfer in the multimedia system in JP2002-527824, an access address has to be generated whenever the access address is required. Accordingly, an access address to be specified for a channel to be chained cannot be determined as soon as a channel activated previously is set. That is, the accelerator (data streamer) can be activated only after it is determined that a channel issued previously is terminated. Thus, data transfer cannot be performed using chained channels.

Thus, the CPU has to be synchronized with the data streamer so that the throughput of the CPU deteriorates substantially. In addition, the rate of operation of the accelerator also deteriorates.

### SUMMARY OF THE INVENTION

The present invention was developed in consideration of these problems. It is an object of the invention to provide a processor system which can perform high-speed image processing.

In order to attain the foregoing object, the invention is implemented as follows.

A processor system according to the invention includes a CPU and an accelerator. The CPU connected to the accelerator issues reservation of an activation request to the accelerator. The accelerator includes an issued request number counter for counting the number of requests issued by the CPU and a processed request number counter for counting the number of processed requests. The accelerator includes an execution-reservable accelerator which can activate the accelerator itself when a counter value of the issued request number counter is larger than a counter value of the processed request number counter.

Then, it will be possible to provide a processor system capable of performing high-speed image processing.

### BRIEF DESCRIPTION OF THE DRAWINGS

FIG. 1 is a diagram for explaining the configuration of an image processing system as a processor system according to an embodiment of the invention;

FIG. 2 is a diagram for explaining the outline of an MPEG decoding process sequence;

FIG. 3 is a diagram for explaining a motion compensation process in the MPEG decoding process;

FIG. 4 is a diagram for explaining the details of a valid request determination circuit 31;

FIG. 5 is a diagram for explaining the details of a descriptor storage circuit 32;

FIG. 6 is a diagram for explaining the details of a shared register 33;

FIG. 7 is a diagram for explaining the details of an address generator 36;

FIG. 8 is a diagram for explaining the details of a motion compensation computing unit 37;

FIG. 9 is a diagram for explaining memory allocation involved in the motion compensation process; and

FIG. 10 is a diagram for explaining the motion compensation process of a compensation accelerator 3.

### DESCRIPTION OF THE EMBODIMENT

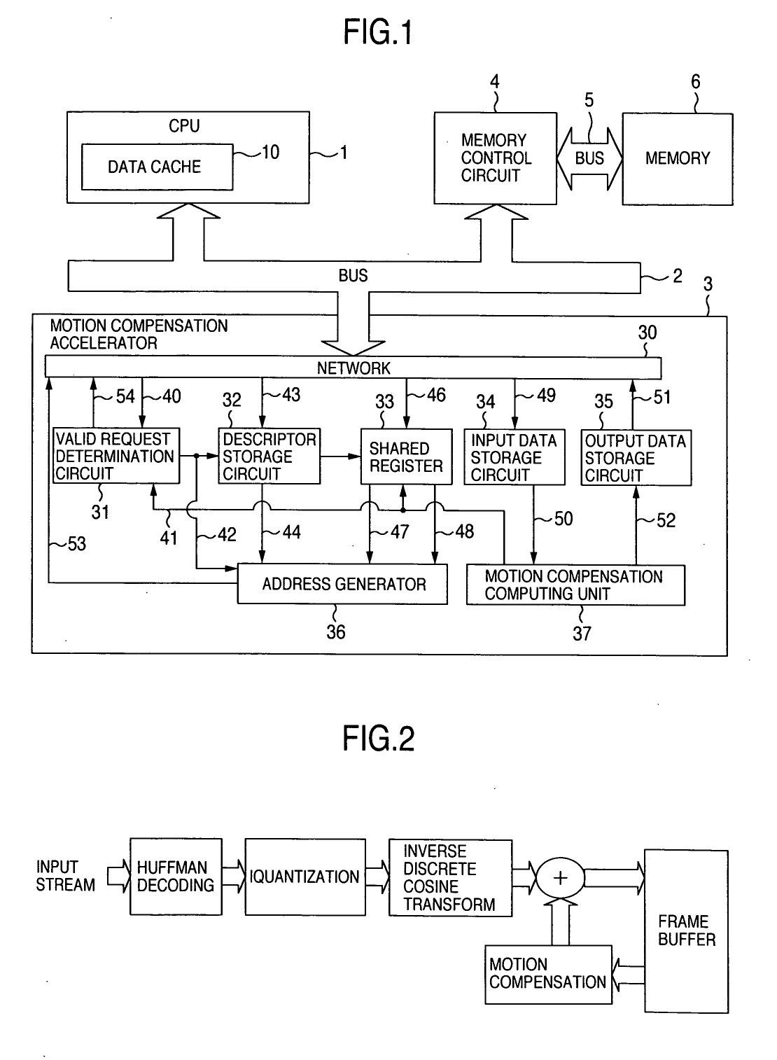

An embodiment of the invention will be described below with reference to the accompanying drawings. FIG. 1 is a diagram for explaining the configuration of an image processing system as a processor system according to the embodiment.

The image processing system includes a CPU 1, a motion compensation accelerator 3 and a memory control circuit 4, which are connected via a bus 2. The CPU 1 includes a data cache 10 and performs general-purpose computing or media computing. The motion compensation accelerator 3 performs a motion compensation process in an MPEG decoding process. A memory 6 such as a main storage is connected to the memory control circuit 4 through a path 5. The CPU 1 can gain access to the motion compensation accelerator 3 and the memory control circuit 4 through the bus 2 and a network 30.

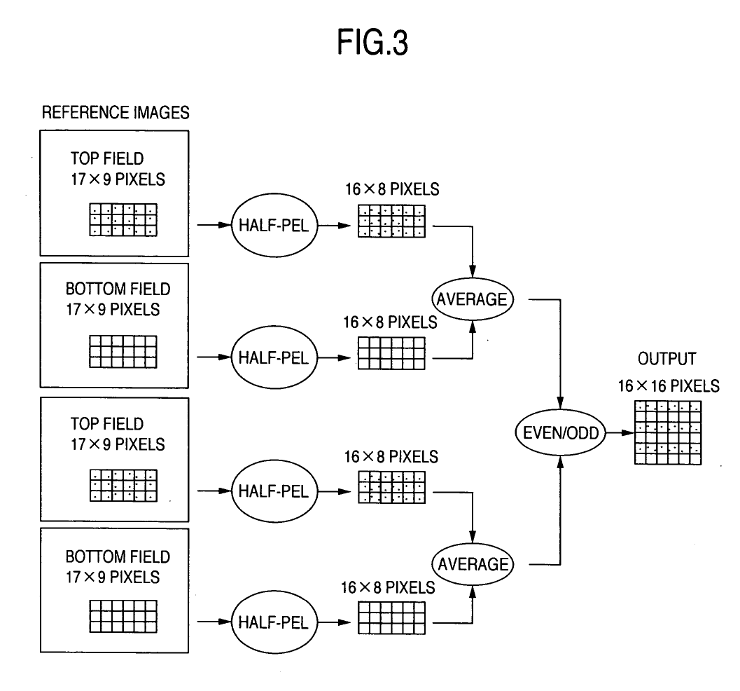

Prior to detailed description of the motion compensation accelerator 3, description will be first made about the outline of a processing sequence of an MPEG decoding process with reference to FIGS. 2 and 3.

FIG. 2 is a diagram for explaining the outline of the MPEG decoding process sequence. Image data are generated from a compressed input stream through a Huffman decoding circuit, an iquantization circuit and an inverse discrete cosine transform circuit. The generated image data are stored in a frame buffer. In a decoding process using motion vectors, an image obtained by a motion compensation process is added to an image obtained by a previous sequence so as to generate image data.

FIG. 3 is a diagram for explaining the motion compensation process in the MPEG decoding process, showing a dual prime prediction system for frame images, which is an example of the motion compensation process. This process is a process in which a rounded average of adjacent pixels in half pixel precision is obtained based on four reference images each measuring 17 pixels by 9 pixels, and an image measuring 16 pixels by 16 pixels is obtained. Thus, the motion compensation accelerator 3 is an accelerator which reads the reference images in accordance with a motion prediction mode such as a dual prime prediction mode, a frame prediction mode, a field prediction mode or a 16×8 MC prediction mode in MPEG-2, or a frame prediction mode, a field prediction mode or an 4MV prediction mode in MPEG-4, and performs rounded average computing.

Next, with reference to FIG. 1, description will be made about the motion compensation accelerator 3. The motion compensation accelerator 3 has two functions, that is, a function as a slave accessible from the CPU 1 via the bus 2 and the network 30 and a function as a master gaining active access via the network 30 and the bus 2 using an address generated by an address generator 36 in the motion compensation accelerator 3.

When the motion compensation accelerator 3 operates as the slave, a valid request determination circuit 31, a descriptor storage circuit 32 and a shared register 33 are blocks accessible via the network 30. When the motion compensation accelerator 3 operates as the master, the motion compensation accelerator 3 performs three kinds of access operations, that is, an operation of reading a descriptor into the descriptor storage circuit 32, an operation of reading reference images into an input data storage circuit 34 and an operation of outputting a motion compensation result from an output data storage circuit 35.

The valid request determination circuit 31 determines whether to activate the motion compensator accelerator 3 or not. The descriptor storage circuit 32 is a block for saving parameters required for the motion compensation process. The parameters are provided for each macroblock and defined in a descriptor format. The parameters include a prediction mode etc. The shared register 33 is a register for saving parameters or the like having no change during the MPEG decoding process of one frame. The address generator 36 generates a descriptor read address, a reference image read address and a motion compensation result output address. The input data storage circuit 34 is a block for saving the reference images. The motion compensation computing unit 37 is a computing unit for receiving reference image data 50 stored in the input data storage circuit 34, and computing a rounded average based on dual prime prediction or the like. The motion compensation computing unit 37 generates a motion compensation computing result 52 and outputs it to the output data storage circuit 35. A generated motion compensation result 51 output from the output data storage circuit 35 is supplied to the bus 2 via the network 30.

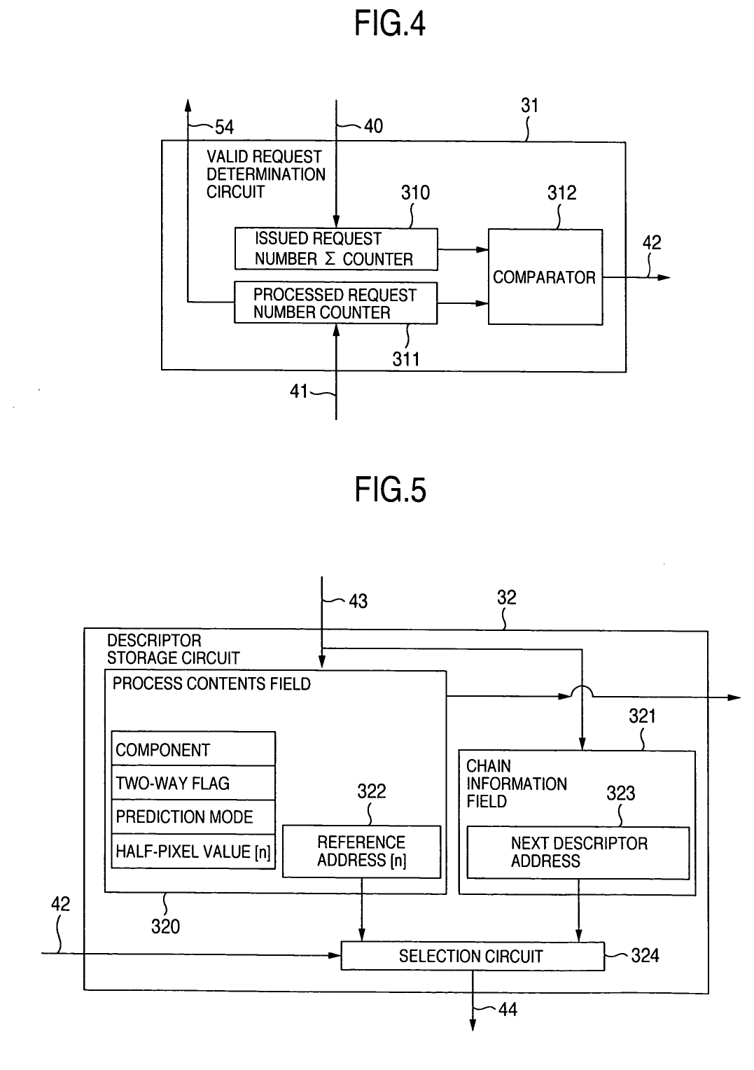

FIG. 4 is a diagram for explaining the details of the valid request determination circuit 31. The valid request determination circuit 31 has two kinds of counters, that is, an issued request number Σ counter 310 and a processed request number counter 311. The issued request number Σ counter 310 counts the number of requests 40 to activate the motion compensation accelerator 3 one by one. The processed request number counter 311 counts the number of motion compensation computing termination events 41 one by one. Each motion compensation computing termination event 41 indicates that the motion compensation accelerator 3 has terminated computing. Counter values of these counters are put into a comparator 312. When the counter value of the issued request number Σ counter 310 is larger than the counter value of the processed request number counter 311, it is concluded that there is a valid request. Thus, a valid request 42 is created and output. In addition, the accelerator 3 processes a request from the CPU to the accelerator based on the valid request 42.

In this embodiment, at least means for clearing the counter values of the issued request number Σ counter 310 and the processed request number counter 311 to “0” concurrently is provided. Here, the counter values of the issued request number Σ counter 310 and the processed request number counter 311 are set in registers that can be accessed concurrently. When values “0” are written into the two registers, the registers are cleared to “0”. Due to the “0” clear, it is possible to establish that there is no invalid request.

Alternatively, two address spaces may be provided for each of the counter values of the issued request number Σ counter 310 and the processed request number counter 311. In this case, one of the address spaces is defined as an area which is read/write accessible, while the other is defined as an area which can be cleared to “0” in response to access to the area.

Next, description will be made about a system for setting the counter value of the issued request number Σ counter 310. According to a first system, for example, a written datum itself is regarded as the number of requests. In this example, first the counter value is cleared to “0”, and the number of requests “1” is then written as the counter value. As a result, the issued request number Σ counter 310 stores “1”. Next, for example, the number of requests “3” is written. In this case, “4” obtained by adding “3” to the counter value “1” is stored as the issued request number Σ counter value. Thus, sigma addition can be implemented to store the total sum of requests issued in the past. That is, here, the fact that four requests have been issued is stored.

According to a second system, the counter value is cleared to “0” when a value “0” is written into the register as described above, and the counter value of the issued request number Σ counter 310 is increased by “1” whenever a value other than “0” is written into the register. Thus, the written number other than “0” can be set as the number of requests.

According to a third system, the CPU 1 itself stores the number of requests issued until then, with the aid of software. Thus, the number of requests stored by the CPU 1 itself can be directly set as the counter value of the issued request number Σ counter 310. Incidentally, a processed request number counter value 54 may be transferred to the CPU 1 after the motion compensation computing result 52 is transferred.

FIG. 5 is a diagram for explaining the details of the descriptor storage circuit 32. The descriptor storage circuit 32 stores information required for the motion compensation process, such as a prediction mode provided for each macroblock and defined in a descriptor format. The descriptor is saved as data in the data cache 10 of the CPU 1 or in the memory 6.

The process for storing the saved descriptor data 43 into the descriptor storage circuit 32 is not a process for storing based on a write operation from the CPU 1 or the like, but a process as follows. That is, when the valid request 42 is asserted (validated) and it is concluded that there is a valid motion compensation process request, the motion compensation accelerator 3 itself reads the descriptor data 43 out onto the bus 2 actively, and stores it into various registers in the descriptor storage circuit 32.

The descriptor storage circuit 32 has two kinds of register fields. First, a process contents field 320 is constituted by a component portion of a luminance component, chrominance components (Cb and Cr), etc., a two-way flag portion indicating one-way prediction or two-way prediction, a prediction mode portion indicating a prediction mode such as a dual prime prediction mode, a field prediction mode, a frame prediction mode, a 16×MC prediction mode, etc., half-pixel value [n] portions serving to obtain a rounded average, reference address [n] portions 322 each indicating a read address of a reference image, and so on. On the other hand, a chain information field 321 has a next descriptor address portion 323 indicating an address where a next descriptor has been stored.

Incidentally, the next descriptor address may be expressed in an addressing system using an absolute address where the next descriptor has been stored, or in an addressing system in which the next descriptor address is defined as an offset as in a relative addressing system, that is, defined as an address relative to the address of the current descriptor. In accordance with necessity to refer to a plurality of fields, there are provided [n] sets of half-pixel value [n] portions and reference address [n] portions 322.

The process contents field 320 serves to read out reference images for the motion compensation process or to set a mode of motion compensation computing. The chain information field 321 serves to read out the next descriptor. These fields can be subjected to data access processes through the bus 2. For the data access, one reference address [n] portion 325 or the next descriptor address portion 323 is selected by a selection circuit 324 and read out to generate an address 44. The generated address 44 is transferred to the address generator 36.

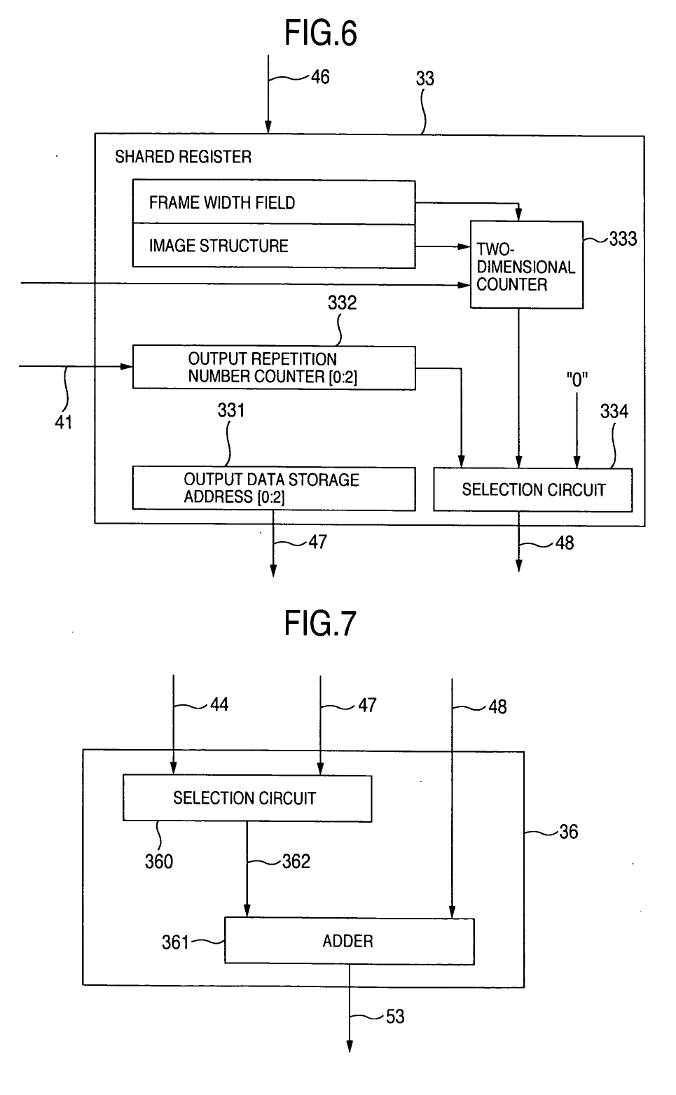

FIG. 6 is a diagram for explaining the details of the shared register 33. The shared register 33 stores not parameters required for each macroblock but parameters 46 required for a motion compensation process sequence of one frame. The register into which data can be written via the network 30 has a frame width field indicating the width of an image, an image structure indicating a frame image or a field image, output data storage addresses [0:2] 331, and output repetition number counters [0:2] 332 for specifying the number of buffer repetitions of an area where output data are stored.

Each output repetition number counter [0:2] 332 indicates an upper limit value of the set number of output destinations defined like a ring buffer. When the counter value reaches the upper limit value, a two-dimensional counter 333 is cleared to zero. The two-dimensional counter 333 storing output storage destination output data is a register for performing sigma addition on the frame width field. The two-dimensional counter 333 adds the frame width field to its own counter value when a two-dimensional reference image is read out. In the field prediction mode or the dual prime prediction mode according to an MPEG decoding process, a value twice as large as the frame width field is added to support a field image having a double read pitch.

The selection circuit 334 is a selector for selecting the value of the output repetition number counter 332 for outputting a motion compensation result, the output of the two-dimensional counter 333 for reading out a reference image, and a value “0” for reading out a descriptor, so as to generate an offset address 48. The generated address is output to the address generator 36. An address generated likewise by the output data storage address [0:2] portion 331 is output to the address generator 36.

Here, in order to support a luminance component and chrominance components (Cb and Cr) in image processing, there are provided three output data storage address [0:2] portions 331 and three output repetition number counters [0:2] 332. The output destination of each portion or counter can be specified.

FIG. 7 is a diagram for explaining the details of the address generator 36. The address generator 36 generates three addresses, that is, a descriptor read address, a two-dimensional reference image read address and a motion compensation result output destination address. A selection circuit 360 selects the read address 44 for reading a descriptor and for reading a two-dimensional reference image, and an output storage address 47 for outputting a motion compensation result. A base address 362 which is an output of the selection circuit 360 is added to the offset address 48 by an adder 361 so as to generate an access address 53. The motion compensation accelerator 3 gains access to the bus 2 via the network 30 using the access address 53.

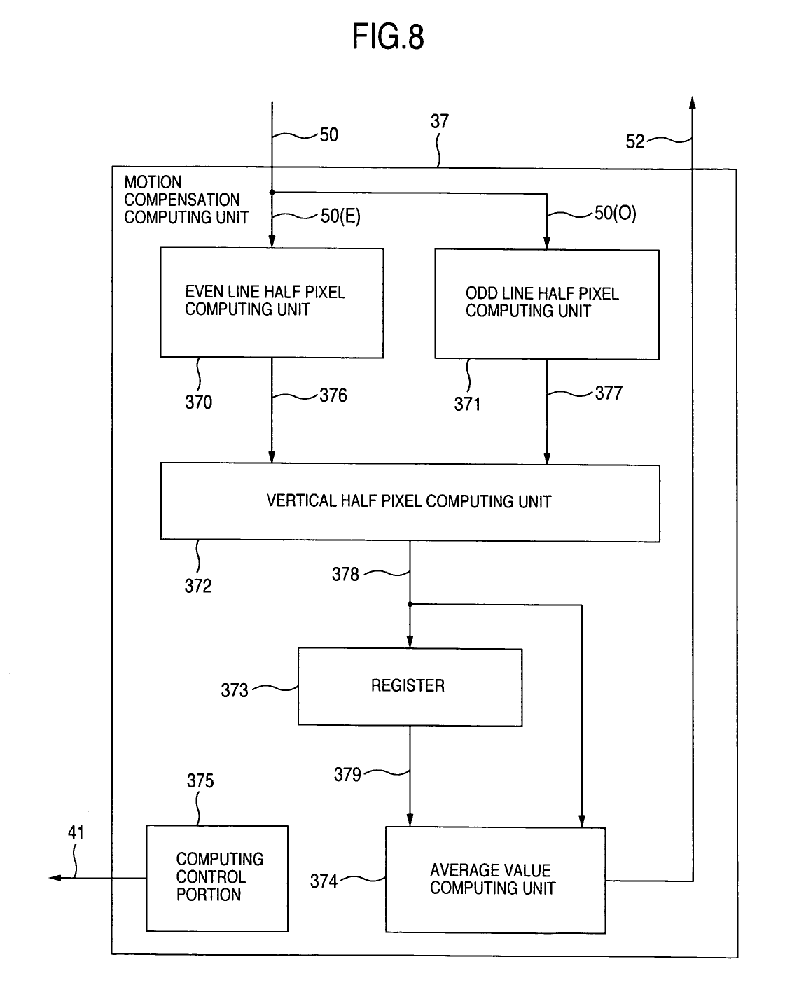

FIG. 8 is a diagram for explaining the details of the motion compensation computing unit 37. This example is designed so that two lines of an even line and an odd line can be read out from the reference image data 50 output from the input data storage circuit 34 at a time. An even line half pixel computing unit 370 computes a horizontal half pixel value 376 of the even line from even line reference data 50(E). An odd line half pixel computing unit 371 computes a horizontal half pixel value 377 of the odd line from odd line reference data 50(O). The horizontal half pixel values 376 and 377 are put into a vertical half pixel computing unit 372 so as to obtain a rounded average value 378 of a total of four vertical and horizontal pixels. When half pixel values in the process contents field 320 show that there is no necessity to obtain a rounded average, control is made not to compute the rounded average. That is, the even line reference data 50(E), the odd line reference data 50(O), the even line horizontal half pixel value 376 and the odd line horizontal half pixel value 377 which are to be put into their corresponding computing units are masked, while shifters are provided in output stages of the computing units respectively.

Further, in the dual prime prediction mode and the two-way prediction mode, pipeline processing is performed to obtain an average of two 4-pixel rounded average values 378 in an average value computing unit 374. A 4-pixel rounded average value 379 which is an output of a register 373 storing a 4-pixel rounded average value 378, and a rounded average value 378 of corresponding pixels are put into the average value computing unit 374 so as to obtain a final motion compensation computing result 52. Also in the average value computing unit 374, computing can be masked by a mask and a shifter in the average value computing unit 374 when there is no necessity to compute the average value. Through these various MPEG motion compensation computing processes, final motion compensation computing results 52 can be obtained by controlling the input order of the reference image data 50 to be input and the output order of the final motion compensation computing results 52 to be output. The orders depend on the image structure indicating a frame image or a field image, the two-way flag indicating one-way prediction or two-way prediction, the prediction mode indicating a prediction mode used for an image to be decoded, such as a frame prediction mode, a field prediction mode, a dual prime prediction mode or a 16×MC prediction mode in MPEG-2, or a 4MV prediction mode in MPEG-4, etc., and the half-pixel values as shown in FIGS. 5 and 6. Based on these values, a read pointer of the output data storage circuit 35 and a write pointer of the output data storage circuit 35 are controlled.

A computing control portion 375 is a main control portion of the motion compensation computing unit 37, which portion controls the computing unit itself, and generates a motion compensation computing termination event 41 as soon as the motion compensation process of one macroblock is terminated.

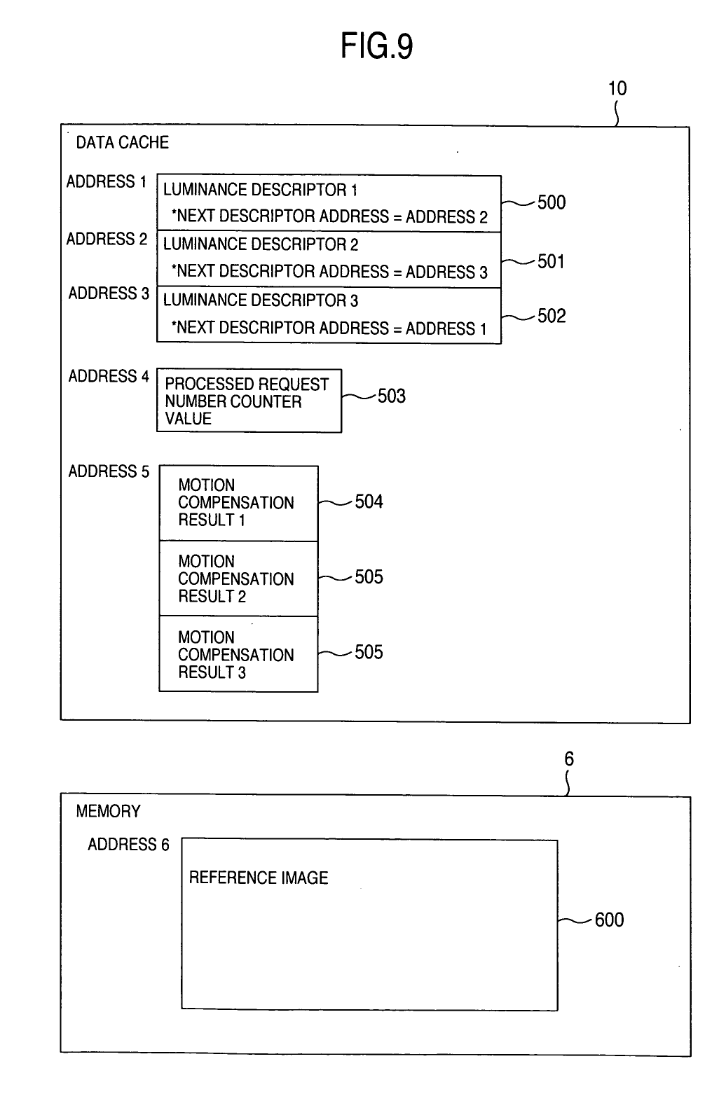

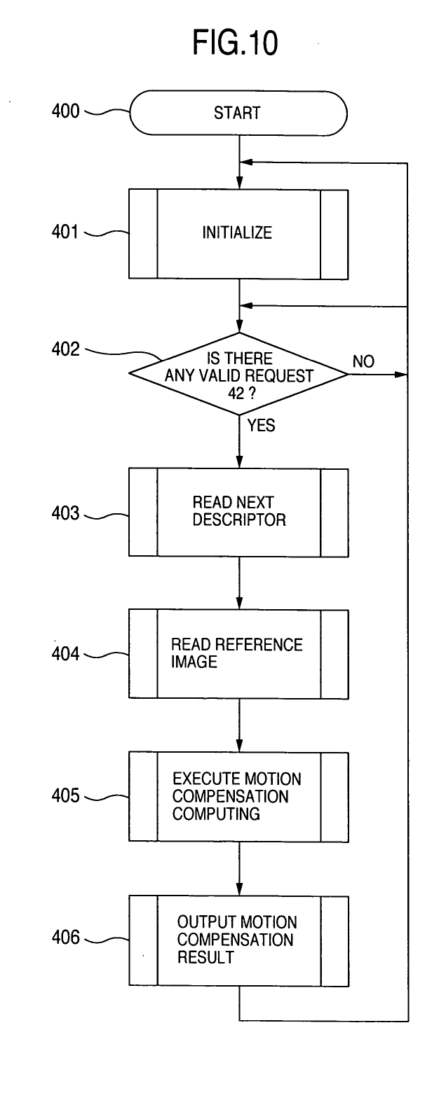

Next, with reference to FIGS. 9 and 10, description will be made about the motion compensation process using the motion compensation accelerator 3. In this process, Huffman decoding, iquantization, inverse discrete cosine transform, and addition to a motion compensation result are executed by the CPU 1 in accordance with an MPEG decoding process sequence as shown in FIG. 2, while the motion compensation process is performed in the motion compensation accelerator 3. In order to simplify the description, a mode for performing an MPEG decoding process only on a luminance component is used here.

FIG. 9 is a diagram for explaining memory allocation involved in the motion compensation process. Descriptor areas 500, 501 and 502, a processed request number counter area 503, and motion compensation result storage areas 504, 505 and 506 are defined in the data cache 10 of the CPU 1. In this example, each descriptor and each motion compensation result are defined in a triple buffer format so that a maximum of three motion compensation accelerators 3 can be activated. A next descriptor address is stored like a chain in each descriptor so that the descriptor can be chained to the next descriptor automatically (500, 501 and 502). The three motion compensation result areas 504, 505 and 506 are provided for using triple buffers, while “3” is set in the output repetition number counter 332 (FIG. 6) in the shared register 33. The processed request number counter area 503 is updated with the value of the processed request number counter value 54 by the motion compensation accelerator 3 itself after motion compensation results have been written into the motion compensation result areas 504, 505 and 506. Due to these areas disposed on the data cache 10, the CPU 1 can gain access only with reference to the data cache. Thus, the access performance can be improved. Incidentally, a reference image 600 is stored in the memory 6.

FIG. 10 is a diagram for explaining the motion compensation process of the accelerator 3. First, after starting the process (Step 400), the CPU 1 initializes the motion compensation accelerators 3. For example, the CPU 1 sets “3” in the frame width field, the image structure and the output repetition number counter in the shared register 33, sets an address 5 in the output data storage address 331, clears the issued request number Σ counter 310 and the processed request number counter 311 in the valid request determination circuit 40, and sets an address (address 1) where the first descriptor has been stored, in the next descriptor address 323 in the descriptor storage circuit 32. In addition, the processed request number counter value area 503 on the data cache is cleared (Step 401).

At this time, the motion compensation accelerators 3 can be activated, and they are in wait state until the valid request 42 is asserted in accordance with the operation of the valid request determination circuit 31. The CPU 1 sets the luminance descriptor area 500 in the data cache 10, and then sets “1” in the issued request number Σ counter 310. As soon as “1” is set, the valid request 42 is asserted, and the motion compensation accelerators 3 are activated (Step 402).

First, based on the address set in the next descriptor address 323, a luminance descriptor 1 is read from the data cache 10 (FIG. 9), and the descriptor storage circuit 32 is updated (Step 403). Next, based on the process contents field 320 stored in the descriptor storage circuit 32, a reference image is read from the memory 6 (Step 404). Motion compensation computing is executed by the motion compensation computing unit 37, and a motion compensation computing result 52 is stored in the output data storage circuit 35. In this event, the motion compensation termination event 41 is asserted, and the processed request number counter 311 is counted up (Step 405).

Next, the motion compensation result 51 is transferred to the motion compensation result 1 area 504 on the data cache 10 based on the output data storage address 331. After the transfer, the value of the processed request number counter 311 is transferred to the processed request number counter value area 503 on the data cache 10 (Step 406). At this time, the motion compensation accelerators again determine where there is a valid request 42 or not (Step 402). Due to such a sequence of processes, the motion compensation accelerators 3 can be activated like a chain. In addition, matching in access of each motion compensation accelerator 3 can be secured between the data cache 10 and the memory 6 by snoop technology.

As described above, according to this embodiment, the CPU 1 can reserve activation of each motion compensation accelerator 3 only by polling the activation requests (issued request number Σ counter value) of the motion compensation accelerator 3 and the processed request number counter value 503 on the data cache 10. That is, it is not necessary to poll the operating status of the motion compensation accelerator 3 (as to whether the motion compensation accelerator 3 can be activated or not). In addition, activation of the motion compensation accelerators 3 can be reserved in accordance with the set number of the descriptor areas 500, 501 and 502 and the motion compensation result areas 504, 505 and 506 defined on the data cache 10. Further, wasteful stop periods of the accelerators occurring among a plurality of activation requests can be saved, so that the throughput of the system as a whole can be improved.

Although the above description has been made specially about a motion compensation process in an MPEG decoding process, the present invention is not limited thereto. For example, the invention is likewise applicable to a general system including an accelerator operating in accordance with a descriptor.

1. A processor system comprising:
a CPU; and
an accelerator;
said CPU being connected to said accelerator and issuing reservation of an activation request to said accelerator;
said accelerator including an issued request number counter for counting the number of requests issued by said CPU and a processed request number counter for counting the number of processed requests;
said accelerator including an execution-reservable accelerator which activates said accelerator itself when a counter value of said issued request number counter is larger than a counter value of said processed request number counter.

2. A processor system according to claim 1, wherein said reservation of an activation request issued by said CPU can be executed when said counter value of said issued request number counter is larger than said counter value of said processed request number counter.

3. A processor system according to claim 1, wherein:
said accelerator includes a valid request determination circuit and a descriptor storage circuit, said valid request determination circuit allowing said accelerator to activate itself based on determination that there is a valid request when said counter value of said issued request number counter is larger than said counter value of said processed request number counter, said descriptor storage circuit reading a descriptor from a memory area and storing said descriptor based on said determination that there is a valid request, said descriptor describing contents of a process to be processed by said accelerator; and
said descriptor storage circuit includes a chain information field for specifying a next descriptor storage address to which said descriptor is chained.

4. A processor system according to claim 1, wherein a plurality of accelerators are provided, and a plurality of numbers of issued requests can be set all together in said issued request number counter.

5. A processor system according to claim 1, wherein said counter values of said issued request number counter and said processed request number counter can be cleared concurrently.

6. A processor system according to claim 1, wherein said accelerator updates said counter value of said processed request number counter after termination of computing, and transfers said updated value to said CPU.

7. A processor system according to claim 1, wherein said accelerator is a motion compensation accelerator for performing a motion compensation process in an MPEG decoding process.

8. A processor system according to claim 6, wherein said updated counter value of said processed request number counter is stored in a data cache of said CPU.

9. A processor system according to claim 1, wherein said issued request number counter directly counts written data expressing the number of issued requests.

10. A processor system according to claim 1, wherein said issued request number counter clears said counter value to zero when a value “0” is written, and increases said counter value by one when a value other than “0” is written.

11. A processor system according to claim 1, wherein a stored value of the number of requests issued by said CPU itself is written into said issued request number counter.

12. A method for reserved execution of an accelerator, comprising the steps of:
counting the number of activation requests issued by a CPU and, of said number of issued requests, the number of requests processed by said accelerator; and
allowing said accelerator to activate itself when a counter value of said counted number of issued requests is larger than a counter value of said counted number of processed requests.

13. A method for reserved execution of an accelerator according to claim 12, wherein reservation of each of said activation requests issued by said CPU can be executed when said counter value of said counted number of issued requests is larger than said counter value of said counted number of processed requests.

14. A method for reserved execution of an accelerator according to claim 12, wherein a plurality of numbers of requests issued by said CPU can be set all together.
